(19) United States
(12) Patent Application Publication
(10) Pub. No.: US 2006/0179273 A1
(43) Pub. Date: Aug. 10, 2006

(54) Data processor adapted for efficient digital signal processing and method therefor

(75) Inventors: Terry Lynn Cole, Austin, TX (US); James Nichols, Los Altos, CA (US); William Michael Johnson, Austin, TX (US); Harish Kutagulla, Austin, TX (US)

Correspondence Address: LARSON NEWMAN ABEL POLANSKY & WHITE, LLP, 5914 WEST COURTYARD DRIVE, SUITE 265, AUSTIN, TX, 78730, US

(73) Assignee: Advanced Micro Devices, Inc.

(21) Appl. No.: 11/054,220

(22) Filed: Feb. 9, 2005

(51) Int. Cl. G06F 15/00

(52) U.S. Cl. 712/34

(57) ABSTRACT

A data processor (200) includes a processor core (300), an interface (210) coupled to the processor core (210), and a coprocessor (500). The coprocessor (500) is coupled to the processor core (300) via the interface (210) and includes a first list memory (522). In response to a predetermined instruction the processor core (300) provides an operand to the coprocessor (500) via the interface (210). The coprocessor (500) stores the operand in the first list memory (522) and performs an operation corresponding to the predetermined instruction using a plurality of values from the first line memory (522) to provide a result.

### FIELD OF THE DISCLOSURE

The invention relates generally to data processors, and more particularly to data processors capable of performing digital signal processing functions.

### BACKGROUND

Over the last few decades advances in integrated circuit manufacturing technology have allowed microprocessor-based computer systems to move from large warehouses to the desktop and now into handheld devices in such devices as personal digital assistants (PDAs), cellular telephones, smart phones, video games, and the like. A classical computer system was defined by three main components: a central processing unit (CPU), memory, and input/output peripherals. However the CPU and now even memory and some input/output circuitry have been combined into a single integrated circuit chip. These extremely complex devices, sometimes referred to as systems-on-chip or SOCs, have brought the cost of handheld devices down significantly while providing many useful functions.

At the same time the types of processing tasks have also changed. Formerly microprocessors performed integer arithmetic and logical instructions on integer and Boolean data types. While these operations continue to be needed, more specialized processing is also useful for certain devices. One example of specialized processing is floating point arithmetic. Floating point arithmetic is useful in mathematically oriented operations such as complex-graphics. However performing floating-point arithmetic on general-purpose microprocessors designed to process integer and Boolean data types requires complex software routines, and processing is relatively slow. To meet that demand microprocessor designers developed floating-point coprocessors. A coprocessor is a data processor designed specifically to handle a particular task in order to offload some of the processing task from another processor, usually the CPU in the system. Floating-point math coprocessors, such as the 80287 floating point math coprocessor first manufactured by the Intel Corp. of Santa Clara, Calif., were common in desktop computer systems in the 1980s. Floating-point coprocessors improved computer system performance by efficiently handling complex floating-point computations with special purpose circuitry.

Handheld devices also require specialized processing tasks. For example speech signals are often processed in the frequency domain using digital signal processors (DSPs). Thus it seems natural to add DSP coprocessors to general-purpose data processors in handheld devices.

It is also desirable to use highly integrated SOCs in these handheld devices to reduce component count and cost. Thus far it has been difficult to integrate DSP coprocessors with general-purpose CPUs in SOCs. The SOC design philosophy requires the circuit blocks to be modular so that they can be re-used. The CPU is usually designed as a “core” and may even be synthesizable from a high level description using computer-aided design (CAD) techniques. However a coprocessor requires a complex interaction with the instruction pipeline of the CPU, and changing the design of the CPU to accommodate a DSP coprocessor destroys modularity.

Because of this difficulty some designs have used a separate, general-purpose DSP alongside the CPU. The DSP was similar to the CPU because it accessed its own memory, had its own instruction set and its own operating system, and required its own set of development tools. However these features increase the cost of the handheld devices. Furthermore the CPU and the DSP communicated using a shared memory, and there was a significant amount of overhead in transferring operands and results between the two devices. Thus the advantages of the special-purpose DSP processing were partly offset by the extra complexity and cost.

In order to overcome these difficulties using modular processor cores in SOC designs, some manufacturers have recently designed processor cores with additional “hooks” for use in systems with optional coprocessors. For example, the 4KES™ RISC microprocessor core available from MIPS Technologies, Inc. of Mountain View, Calif. includes a special set of coprocessor instructions and a special purpose interface to allow instructions and data to be passed between the CPU core and the coprocessor. Thus when the CPU core decodes one of these special coprocessor instructions, it retrieves the appropriate operands from the register file and passes them along with the instruction over a special interface to the coprocessor. The CPU core's pipeline is halted while the coprocessor performs the instruction. When the coprocessor returns the result of the instruction, the CPU core stores the result in the register file and continues processing instructions in the pipeline.

What is needed then is a data processor that uses this new capability of RISC microprocessor cores to provide smaller, lower power SOCs useful for handheld electronic devices and the like.

### BRIEF SUMMARY

Thus in one form the present invention provides a data processor including a processor core, an interface coupled to the processor core, and a coprocessor. The coprocessor is coupled to the processor core via the interface and includes a first list memory. In response to a predetermined instruction the processor core provides an operand to the coprocessor via the interface. The coprocessor stores the operand in the first list memory and performs an operation corresponding to the predetermined instruction using a plurality of values from the first list memory to provide a result.

In another form the present invention provides coprocessor for use in a data processor including a central processing unit that executes instructions. The coprocessor includes control logic, a first list memory, and arithmetic circuitry. The control logic is adapted to be coupled to the central processing unit via an interface, and receives instructions and operands over the interface. The first list memory stores a plurality of values including the operands. The arithmetic circuitry is coupled to the first list memory. Responsive to a predetermined instruction, the control logic causes the arithmetic circuitry to perform an operation corresponding to the predetermined instruction using a plurality of values from the first list memory to provide a result.

In yet another form the present invention provides a data processor including a processor core, an interface coupled to the processor core, and a coprocessor coupled to the interface. In response to a first predetermined instruction the processor core provides an instruction and an operand value to the coprocessor via the interface, and the coprocessor initiates a first predetermined operation according to the first predetermined instruction. In response to a second predetermined instruction the coprocessor provides the result to the interface upon completion of the first predetermined operation.

In still another form the present invention provides a data processing system including a central processing unit, a memory coupled to the central processing unit for storing a plurality of operands, an interface coupled to the central processing unit, and a coprocessor coupled to the interface. The coprocessor includes a first list memory. In response to a predetermined instruction the central processing unit provides an operand to the coprocessor via the interface. The coprocessor stores the operand in the first list memory and performs an operation corresponding to the predetermined instruction using a plurality of values from the first list memory to provide a result.

In yet another form the present invention provides a method for efficiently operating a data processing system. An operand is loaded into a register of a central processing unit in response to a first instruction. The operand is provided from the register to an interface in response to a second instruction. The operand is stored in a first list memory of the coprocessor in response to the second instruction. A predetermined operation corresponding to the second instruction is performed in the coprocessor using a plurality of values from the first list memory to provide a result.

### BRIEF DESCRIPTION OF THE DRAWINGS

The present disclosure may be better understood, and its numerous features and advantages made apparent to those skilled in the art by referencing the accompanying drawing, in which like reference numbers indicate similar or identical items.

FIG. 1 illustrates in block diagram form a data processing system known in the prior art;

FIG. 2 illustrates a block diagram form a data processing system according to the present invention;

FIG. 3 illustrates in block diagram form the RISC processor core of FIG. 2;

FIG. 4 illustrates in block diagram form the coprocessor instruction format used by the RISC processor core of FIG. 3; and

FIG. 5 illustrates in block diagram form the DSP list coprocessor of FIG. 2.

### DESCRIPTION OF THE PREFERRED EMBODIMENT(S)

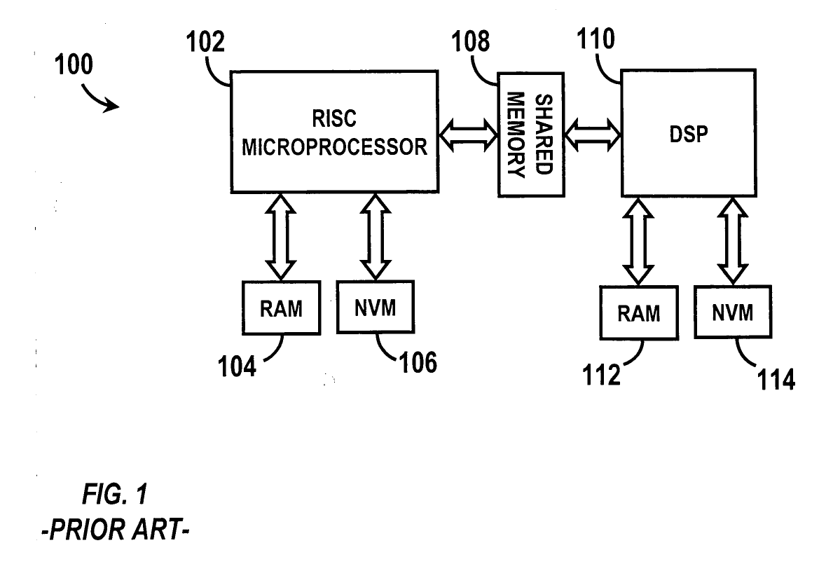

FIG. 1 illustrates in block diagram form a data processing system 100 known in the prior art. Data processing system 100 includes a reduced instruction set computer (RISC) microprocessor 102 that forms the central processing unit (CPU) of system 100. RISC microprocessor 102 is connected to high-speed volatile memory in the form of a random access memory (RAM) 104, and lower speed nonvolatile memory (NVM) 106 which may be in the form of a mask read only memory (ROM), a flash electrically erasable programmable read-only memory (“FLASH”), or the like. System 100 also includes input/output devices connected to RISC microprocessor 102 either directly or through input/output adaptors, not shown in FIG. 1.

In order to perform specialized processing required for a handheld device such as a PDA, cellular telephone, handheld video game system, and the like, system 100 includes a general-purpose digital signal processor (DSP) 110 having its own RAM 112 and NVM 114 respectively for data and program storage. In order to pass tasks and results between RISC microprocessor 102 and DSP 110, system 100 includes a shared memory 108.

There are several deficiencies of computer system 100 when used for low-cost hand held devices. First, RISC microprocessor 102 and DSP 110 are separate chips, adding to system cost. Second, each processor requires its own separate memory, increasing chip count and thus system cost. Third, because each processor has its own instruction set, each requires its own separate assembler, compiler, and development tools, thereby increasing complexity and decreasing time-to-market.

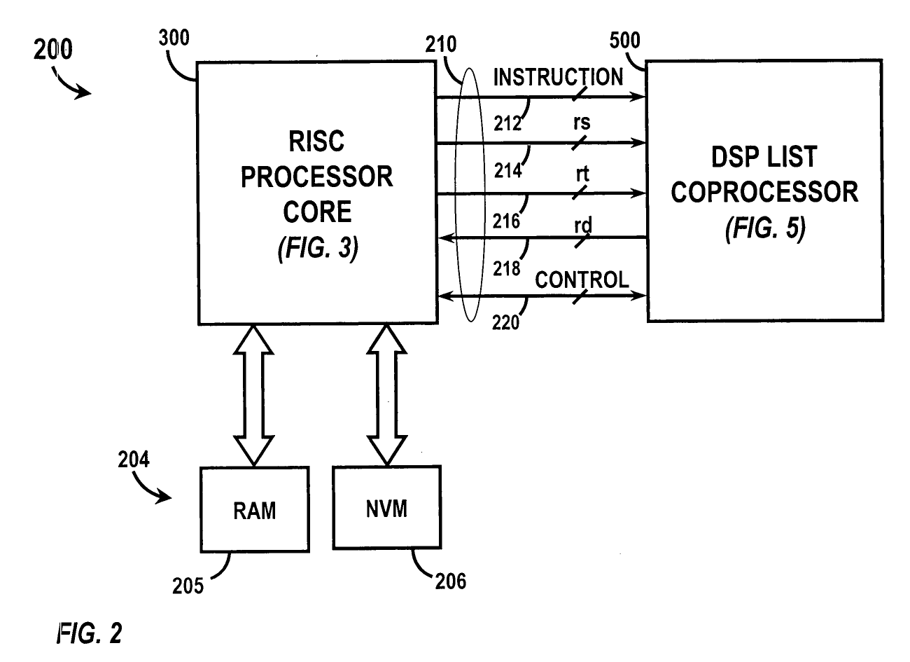

FIG. 2 illustrates a block diagram form a data processing system 200 according to the present invention. Data processing system 200 includes a RISC processor core 300, a memory 204 including RAM 205 and NVM 206, an interface 210, and a special DSP list coprocessor 500. As before, NVM 206 can take the form of mask ROM, flash EEPROM, etc. In the exemplary embodiment RISC processor core 300, interface 210, and DSP list coprocessor 500 are combined in a single integrated circuit. Unlike RISC processor core 102 in FIG. 1, RISC processor core 300 is adapted for integration with other system components including coprocessors. Accordingly RISC processor core 300 includes a special capability for recognizing coprocessor instructions defined by the user and providing these special instructions to a coprocessor via interface 210. In the illustrated embodiment RISC processor core 300 is a core compatible with the 4KES™ Processor Core Family available from MIPS Technologies, Inc. of Mountain View, Calif., but could be replaced by an equivalent processor core with similar functionality.

Interface 210 is the point of interaction between RISC processor core 300 and DSP list coprocessor 500. Interaction is achieved through signal lines to transfer data between these processors and to control the interface. Pertinent signal lines are described as follows but is should be apparent that these are only exemplary. A set of thirty-two signal lines 212 labeled “INSRUCTION” corresponds to one or more instructions in the instruction set of RISC processor core 202. In the case of the 4KES™ core, some instructions that were previously reserved have now been dedicated for use with the coprocessor. These instructions, referred to as user-defined interface (UDI) instructions, have a portion of the instruction field that identifies it as a UDI instruction, and another portion of the instruction field that identifies the type of operation to be performed. RISC processor core 300 uses the INSTRUCTION field to indicate, at a minimum, the type of UDI instruction being conveyed to DSP list coprocessor 500. Thus the INSTRUCTION field may be identical to the RISC processor core instruction, but may also include a fewer number of bits as long as there is a sufficient number to identify the instruction. Furthermore the INSTRUCTION field may encode the instruction in a different fashion than the instruction recognized by RISC processor core 300.

Interface 210 transfers up to two operands to DSP list coprocessor 500 using a first set of thirty-two signal lines for conducting a first operand labeled “rs” and a second set of thirty-two signal lines for conducting a second operand labeled “rt”. One or both of these sets of signal lines may not be required for some UDI instructions.

Interface 210 includes a set of signal lines 218 for transferring a thirty-two bit result operand labeled “rd” by which DSP list coprocessor 500 returns the result of the INSTRUCTION to RISC processor core 300.

Interface 210 also includes a control bus labeled “CONROL” 220 for conducting several control signals that control the operation of interface 210.

RISC processor core 300 and DSP list coprocessor 500 are integrated together with other input/output devices, not shown in FIG. 2, in an SOC. RISC processor core 300 can interface to DSP list coprocessor 500 without modifying its pipeline due to the availability of the UDI.

System 200 only includes a single memory system 204 without the need for either an additional memory dedicated to DSP list coprocessor 500 or a communication memory between RISC processor core 300 and DSP list coprocessor 500. Operand flows occur as follows. RISC processor core 300 first moves data into one of its general-purpose registers in response to a move instruction. The data may be present in memory 204, or may have been received from an input/output device (not shown in FIG. 2). Then RISC processor core 300 executes a UDI instruction that moves the data to DSP list coprocessor 500. DSP list coprocessor 500 includes its own list memory to allow it to perform many different types of DSP tasks without the need for separate memory accesses. In addition due to the sequential nature of many DSP routines, DSP list coprocessor 500 maintains and updates values at the same time it receives an instruction, requiring minimal overhead and intervention by RISC processor core 300 and freeing up additional processing capability. DSP list coprocessor 500 returns the result over rd signal lines 218, and RISC processor core 300 stored the result in the register indicated by the rd field defined by the UDI instruction.

To accomplish efficient DSP processing without additional memory structures DSP list coprocessor 500 includes an internal list memory that stores a list of data values required by many DSP and related instructions. When encountering certain UDI instructions, DSP list coprocessor 500 stores a new operand value in the list memory and performs the instruction using that value and other values already present in the list memory. However in other implementations the value actually transferred may not be used for the present calculation but only stored for later use.

Although not actually implemented by DSP list coprocessor 500, this technique can be used for other special-purpose computations. For example, some data communications tasks require the computation of a frame check sequence in the form of a cyclic redundancy check (CRC). There are several known CRC polynomials, but they all apply the polynomial to a series of data samples to obtain a number. The list memory could be used to store the history of data samples to which a running CRC is calculated. In addition the specific CRC generator polynomial could either be pre-established or could be programmed ahead of time through other instructions. Similarly, DSP list coprocessor 500 could be modified to use the list memory efficiently as part of a general-purpose polynomial evaluation.

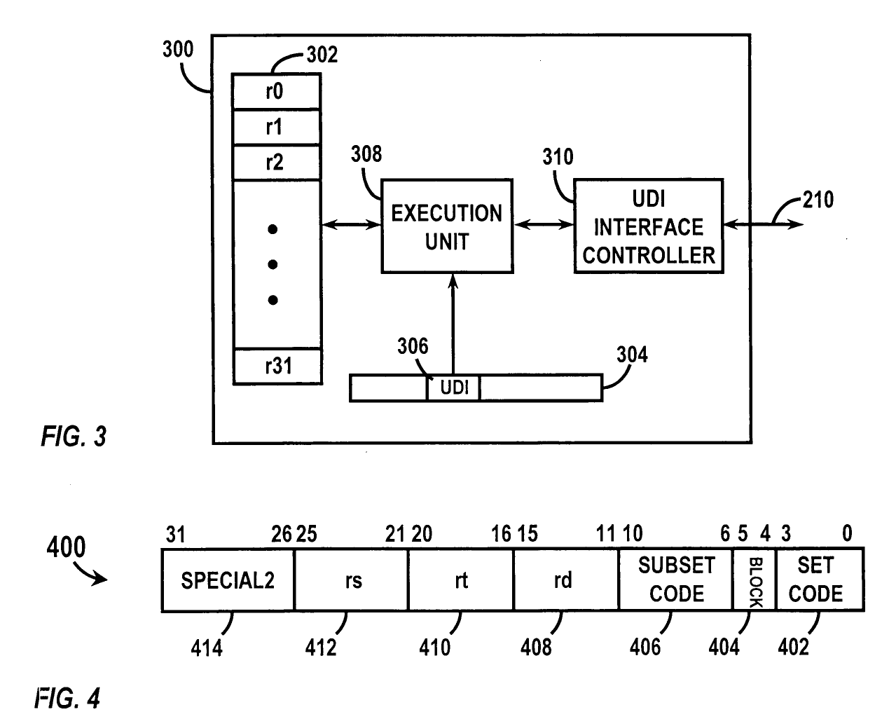

FIG. 3 illustrates in block diagram form RISC processor core 300 of FIG. 2. FIG. 3 illustrates details of RISC processor core 300 that are important to understanding the present invention and omits other, conventional features. RISC processor core 300 includes a general-purpose register file 302. General-purpose register file 302 includes thirty-two registers, each thirty-two bits wide, labeled consecutively “r0”, “r1”, “r2”, etc. through “r31”. In addition RISC processor core 300 includes a configuration register 304 having a bit 306 labeled “UDI” that is used to enable or disable the operation of the user-defined interface. Both UDI bit 306 and the registers in register file 302 are accessible to an execution unit 308, which executes instructions in the instruction repertoire according to a software program.

One class of instructions is the set of UDI instructions. In response to receiving a UDI instruction, when UDI instructions are enabled by UDI bit 306, execution unit 308 delivers a field indicating the instruction and required register values as operands to a UDI interface controller 310. UDI interface controller 310 then controls the exchange of values between RISC processor core 300 and DSP list coprocessor 500 over UDI interface 210.

When enabled by UDI bit 306, execution unit 308 decodes and executes a UDI instruction as shown in FIG. 4, which illustrates the format of a coprocessor instruction 400 used by RISC processor core 300 of FIG. 3. Instruction 400 is a 32-bit instruction with seven fields 402, 404, 406, 308, 410, 412, and 414 of various bit lengths. Bits 3-0 contain a field 402 known as the “SET CODE” field. The SET CODE field identifies the main types of UDI INSTRUCTIONS, including ALU operations, MAC operations, list operations (to be described more fully below), move to and from operations, and extended ALU operations.

Bits 5 and 4 contain a field 404 known as the “BLOCK” field. BLOCK field 404 is always set to 01 for DSP list coprocessor 500.

Bits 10-6 contain a field 406 known as the “SUBSET CODE” field. SUBSET CODE field 406 defines particular operation codes (opcodes) recognized by DSP list coprocessor 500, and has different meanings based on the value of SET CODE field 402.

The instructions for most SET CODE values cause DSP list coprocessor 500 to perform conventional data processing operations. However DSP list coprocessor 500 is able to perform a special set of operations, known as list operations, thereby taking advantage of the sequential nature of many DSP operations. Thus when SET CODE field 402 indicates a list operation, SUBSET CODE field 406 has the encodings shown in TABLE 1.

TABLE I

| SUBSET | | |
|---|---|---|
| CODE | Mnemonic | Description |
| 00000 | MFXH_COMPLEX | Remove 32-bit packed signed |
| | | complex number (two real 16- |
| | | bit half words) from X head |
| | | and begin pipelined dot |
| | | product of length XLENGTH. |
| | | Returns previous X head (40- |
| | | bit c9b31 accumulation) |
| 00001 | MFXH_COMPLEX_CX | X-list is conjugated before |
| | | dot product |
| 00010 | MFXH_COMPLEX_CXY | X and Y are logically |
| | | conjugated |
| 00011 | MTYH_COMPLEX | Put 32-bit packed signed |
| | | complex number on Y head and |
| | | begin pipelined dot product |
| | | of length XLENGTH/2 with 40- |
| | | bit c9b31 accumulation (ETSI |
| | | doesn't use complex math so |
| | | all MACs are c9b31) |
| 00100 | MTYH_COMPLEX_CX | X-list is conjugated before |
| | | dot product |
| 00101 | MTYH_COMPLEX_CXY | X and Y are logically |
| | | conjugated |
| 00110 | MFXH_REAL | Remove one real int16 from |
| | | X list head and begin |
| | | pipelined real dot product |
| 00111 | MFXH_REAL32 | Remove one real int16 from |
| | | X list head and begin |
| | | pipelined real dot product |
| | | with 1b31 (32-bit) accumu- |
| | | lation and ovf/sat testing |
| | | (ETSI compliant) |
| 01000 | MTYH_REAL | Put one real int16 on Y |
| | | list head and begin |
| | | pipelined real dot product, |
| | | multiplications will |
| | | proceed in parallel, with |
| | | one result (XLENGTH may be |
| | | odd) |
| 01001 | MTYH_REAL32 | Put one real int16 on Y |
| | | list head and begin |
| | | pipelined real 1b31 ETSI- |
| | | spec dot product |
| 01010 | MFXH1 | Move short data from head |
| | | of X, return to caller in |
| | | *rd, XLENGTH decremented |
| 01011 | MFXH2 | Move data pair from head |
| | | of X, decrementing XLENGTH |
| | | by two, returns previous |
| | | XHEAD data pair to caller |
| | | in *rd |
| 01100 | MFYH1 | Move short (16-bit) data |
| | | element from head of Y, |
| | | returns data at previous |
| | | YHEAD to caller in *rd |
| 01101 | MFYH2 | Move listData (packed 2 × 16) |
| | | data from head of Y, |
| | | returns data at previous |
| | | YHEAD to caller in *rd |
| 01110 | MTXT1 | Load a int16 value onto |
| | | tail of X |
| 01111 | MTXT2 | Load packed 2 × 16 onto tail |
| | | of X (representing 1 |
| | | complex or 2 reals), this |
| | | function is used to restore |
| | | X-list context so pairs are |
| | | always loaded for efficiency |
| 10000 | MTYH1 | Place int16 value at head |
| | | of Y, no list integrity |
| | | checking is performed |
| 10001 | MTYH2 | Place data pair at head |
| | | of Y, no list integrity |
| | | checking is performed |

TABLE II shows the operands transferred between RISC processor core 300 and DSP list coprocessor 500 during list instructions:

TABLE II

| SUBSET | | | | | Cy- |
|---|---|---|---|---|---|
| CODE | Mnemonic | Rs | Rt | Rd | cles |
| 00000 | MFXH_COMPLEX | X | X | N/A | Mul- |
| | | | | | tiple |
| 00001 | MFXH_COMPLEX_CX | X | X | N/A | Mul- |
| | | | | | tiple |
| 00010 | MFXH_COMPLEX_CXY | X | X | N/A | Mul- |
| | | | | | tiple |
| 00011 | MTYH_COMPLEX | Operand | X | N/A | Mul- |
| | | | | | tiple |
| 00100 | MTYH_COMPLEX_CX | Operand | X | N/A | Mul- |
| | | | | | tiple |
| 00101 | MTYH_COMPLEX_CXY | Operand | X | N/A | Mul- |
| | | | | | tiple |
| 00110 | MFXH_REAL | X | X | Result | Mul- |
| | | | | | tiple |
| 00111 | MFXH_REAL32 | X | X | Result | Mul- |
| | | | | | tiple |
| 01000 | MTYH_REAL | Operand | X | N/A | Mul- |
| | | | | | tiple |
| 01001 | MTYH_REAL32 | Operand | X | N/A | Mul- |
| | | | | | tiple |
| 01010 | MFXH1 | X | X | Result | 1 |
| 01011 | MFXH2 | X | X | Result | 1 |
| 01100 | MFYH1 | X | X | Result | 1 |
| 01101 | MFYH2 | X | X | Result | 1 |
| 01110 | MTXT1 | Operand | X | N/A | 1 |
| 01111 | MTXT2 | Operand | X | N/A | 1 |
| 10000 | MTYH1 | Operand | X | N/A | 1 |
| 10001 | MTYH2 | Operand | X | N/A | 1 |

in which “X” represents a don't-care, and “Multiple” indicates that the number of cycles depends on the number of elements in (i.e. the length of) the lists in X memory 524 and/or Y memory 522.

Bits 31-26 form an instruction type field 414 having the binary value “011100” to indicate a so-called “SPECIAL 2” instruction format to indicate, when the BLOCK field also has the value 01, that the instruction is a UDI instruction intended for DSP list coprocessor 500.

The remaining bit fields include operand register designators, each of which is five bits long to select one of the thirty-two general-purpose registers. Bits 25-21 contain a first source operand identifier field 412, labeled “rs”. Bits 20-16 contain a second source operand identifier field 410, labeled “rt”. Bits 15-11 contain a destination operand identifier field 408, labeled “rd”. Whether these fields are used depends on the instruction type.

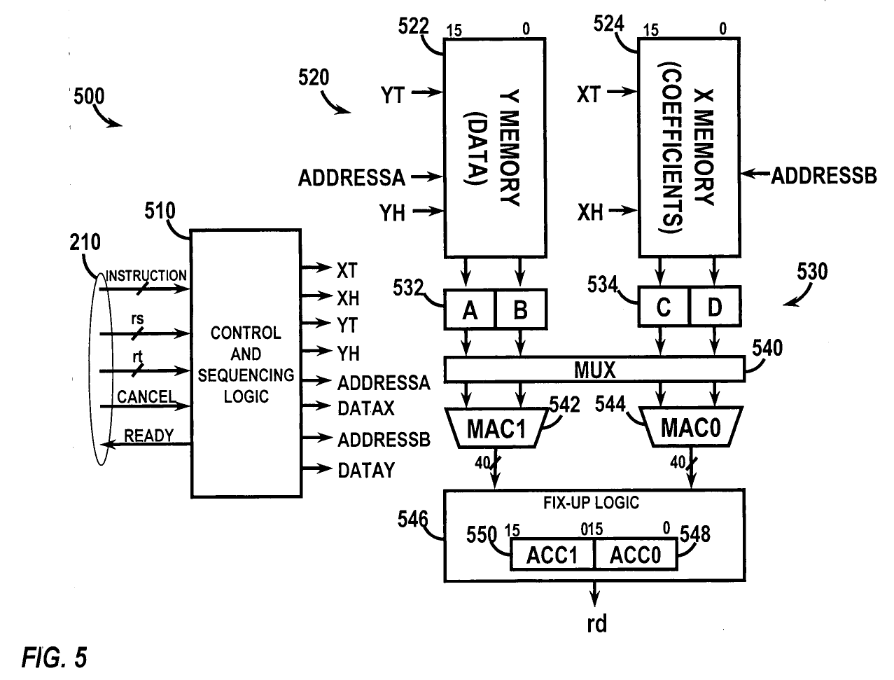

FIG. 5 illustrates in block diagram form DSP list coprocessor 500 of FIG. 2. DSP list coprocessor 500 includes generally control and sequencing logic 510, a list memory 520, and an arithmetic logic unit (ALU) 530. Control and sequencing logic 510 manages UDI interface 210, and decodes instructions indicated by the INSTRUCTION field. It also maintains pointers into list memory 520. These pointers include both a head pointer and a tail pointer for each of a “Y” memory 522 and an “X” memory 524. Thus control and sequencing logic 510 outputs a Y head pointer labeled “YH”, a Y tail pointer labeled “YT”, an X head pointer labeled “XH”, and an X tail pointer labeled “XT”. As will be described further below, the head and tail pointers define the start and end addresses of the sequential lists of values. Control and sequencing logic 510 also outputs an address for indexing into the list in Y memory 522 labeled “ADDRESSA”, an address for indexing into the list in X memory 524 labeled “ADDRESSB”, a data value to be stored in the Y memory labeled “DATAY”, and a data value to be stored in the X memory labeled “DATAX”.

List memory 520 includes both Y memory 522 and X memory 524, each storing 16-bit values. For the purposes of performing one particularly useful DSP operation, a finite impulse response (FIR) filter computation, the values in X memory 524 correspond to coefficients of the filter and the values in Y memory 522 correspond to data samples.

ALU 530 includes registers 532 and 534, a multiplexer (MUX) 540, multiply-and-accumulate (MAC) units 542 and 544, and fix-up logic 546. Register 532 is connected to the output of Y memory 522 and has both an “A” portion and a “B” portion for respectively storing upper and lower bytes of a 16-bit word of data output from Y memory 522. Likewise register 534 is connected to the output of X memory 524 and has both a “C” portion and a “D” portion for respectively storing upper and lower bytes of a 16-bit word of data output from X memory 524. MUX 540 has inputs connected to outputs of the A, B, C, and D registers, and four outputs. MUX 540 is a full 4×4 MUX that is useful in performing packed arithmetic operations, as will be more fully described below. MAC 542 has first and second input terminals connected to the first and second output terminals of MUX 540, and a 40-bit output terminal. MAC 544 has first and second input terminals connected to the third and fourth output terminals of MUX 540, and a 40-bit output terminal. As will be described more fully below, MACs 542 and 544 each have selectable saturation modes to accommodate different saturation assumptions for two well-known types of signal processing.

ALU 530 includes a fix-up logic 546 circuit 546 having a first input terminal connected to the output terminal of MAC 542, a second input terminal connected to the output terminal of MAC 544, and an output terminal connected to interface 210 for providing the rd value. More particularly fix-up logic 546 includes an accumulator having a lower 16-bit portion 548 labeled “ACC0” and an upper 16-bit portion 550 labeled “ACC1”. Accumulator portions 548 and 550 are depicted as being separate portions because they will store separate results when executing packed operations. However when performing full 32-bit arithmetic, the lower portion of the result will be stored in accumulator 548 and the upper portion in accumulator 550. Fix-up circuit 546 performs normalization, scaling, rounding, and saturation as defined by the instruction.

Now considering FIGS. 4 and 5 together, it will be apparent that data processing system 200 executes several coprocessor instructions that can be used as part of efficient signal processing routines. The first instruction is a so-called dot product type of instruction. A dot product instruction multiplies each of the values in a first list by corresponding values in a second list, and sums the products. Thus for example DSP list coprocessor 500 can efficiently perform an FIR filter computation with minimal disruption to the operation of RISC processor core 300. Code running on RISC processor core 300 executes an instruction, for example the MTYH_REAL32 instruction, that delivers a new data sample to the list maintained in Y memory 522, and begins the dot product operation. DSP list coprocessor 500 first adds the data sample to the list by incrementing the head pointer YH and storing the data sample there, and removing the oldest data sample by incrementing the tail pointer, YT. It then reads a coefficient from X memory 524 and a corresponding data sample from data memory 522 using address pointers ADDRESSB and ADDRESSA, respectively and stores them in registers 532 and 534, respectively. MUX 540 routes the operands to one of MAC units 542 and 544, where the multiplication takes place. The sequence continues through remaining coefficient and data values in the list, until the LENGTH is reached. Then the result is provided to fix-up logic 546 for appropriate rounding and saturation. By maintaining list memories in DSP list coprocessor 500, data processor 200 allows the easy integration of RISC processor core 300 and DSP list coprocessor 500 and in a way that requires few external memory accesses. Furthermore the delivery of the new operand to be added to the list and start of computation of a new calculation can begin at the same time.

An important feature of system 200 is that DSP list coprocessor 500 is able to respond to one INSTRUCTION, such as MTYH_REAL32, to begin the dot product calculation and another INSTRUCTION, such as MFXH1, to retrieve the result and store it in a general-purpose register. Thus a software compiler can cause RISC microprocessor core 300 to continue to do useful work while DSP list coprocessor 500 executes the long dot product calculation. The beginning INSTRUCTION (MTYH_REAL32) is not allowed to stall the pipeline, whereas the ending INSTRUCTION (MFXH1) may stall the pipeline if the result is not yet ready. Thus an efficient compiler can use both instructions to avoid wasted cycles associated with coprocessor latency.

Another important feature is that DSP list coprocessor 500 includes two separate MACs each selectable to accommodate different rounding and saturation assumptions. One of them is a 32-bit saturation mode, known as ETSI (European Telecommunication Standards Institute) arithmetic. In the 32-bit saturation mode, DSP list coprocessor 500 saturates partial results to thirty-two bits. Another mode is a 40-bit saturation mode. In the 40-bit saturation mode, DSP list coprocessor 500 accumulates partial results in a 40-bit accumulator and only saturates the final sum to 32 bits at the end of the computation. These two techniques will occasionally yield different results, and DSP list coprocessor 500 preserves the bit accuracy for each of these two algorithms. In other embodiments additional selectable rounding and saturation modes of DSP list coprocessor 500 could also be supported. These selectable modes could support a wide range of mathematical representations, not necessarily linear, which would be useful for such applications as graphics transforms, image processing, and cryptography.

Yet another important feature is the so-called serial MAC mode. In many DSP algorithms, one MAC instruction is immediately followed by another MAC instruction. In such circumstances, it may not be desirable to saturate the MAC results to 32 bits, but rather to combine the unsaturated 40-bit result of the first MAC instruction with the unsaturated 40-bit result of the second MAC instruction. DSP list coprocessor 500 efficiently provides this type of operation using a dual multiply accumulate (DMAC) instruction. Fix-up logic 546 combines two 40-bit results from MAC units 542 and 544 together before saturating the result into 32 bits.

Having two MACs allows DSP list coprocessor 500 to efficiently perform packed arithmetic. For example the operands can be treated as either two 16-bit operands or four 8-bit operands. The two MACs allow two independent multiplies to proceed simultaneously.

Furthermore DSP list coprocessor 500 includes a full complement of instructions, including standard ALU and operand movement instructions that are also useful with the special list and packed arithmetic operations. In order to set the length of the lists, a move to length register (MTL) instruction can be used to move a value on the rd signal lines to an internal LENGTH register.

Thus a data processor as described herein performs efficient signal processing. The data processor provides many advantages over known data processors. First it leverages the capabilities of a general-purpose RISC processor, including memory management in a single large memory pool, a large set of general-purpose registers, general purpose instructions, Harvard architecture of the RISC, and control flow.

Second, by including a special-purpose coprocessor having dedicated circuitry for DSP operations, the data processor performs DSP functions more efficiently while consuming less power.

Third, by requiring no special engine fetches, stores, conflicts, exceptions, etc., the DSP list coprocessor does not disrupt the RISC pipeline.

Fourth, by providing two alternate MAC units of different sizes, the data processor allows a programmer to maintain the bit accuracy of DSP algorithms regardless of whether ETSI-standard calculations or AMD-style calculations are used.

Fifth, the data processor leverages the significantly advanced compiler technologies that exist for the RISC processor core, providing for low level and high level macros that can be included in-line as assembly or C-language code.

Sixth, the DSP list coprocessor includes a relatively small local list memory for storing operands used frequently in DSP operations. The data processor can fetch these operands once from main memory at relatively high power cost, and then use them repetitively within the DSP list coprocessor at relatively low power cost.

Seventh, by making both start and end instructions available for lengthy DSP operations, the data processor allows the CPU's pipeline to continue operating in parallel to the DSP list coprocessor pipeline, stalling the CPU's pipeline only at a later time if the result is not yet available.

Eighth, the DSP list coprocessor has a scalable ALU. In the illustrated embodiment the DSP list coprocessor includes two MAC units, but the number of MAC units can be decreased to only one or increased to a larger number such as four to satisfy different design tradeoffs.

Ninth, the data processor uses a list-based memory architecture that is especially efficient for DSP operations such as FIR filters and convolution. This architecture provides significant reuse of the internal list memory and reduces the need to load new data from main memory, resulting in power savings and processing efficiency.

Tenth, the DSP list coprocessor supports different operand lengths and formats, allowing useful DSP calculations to be performed efficiently. Thus for example the DSP list coprocessor can calculate a single real dot product, two parallel dot products, or a single complex dot product.

Eleventh, the data processor conveniently supports packed arithmetic. Thus the data processor takes advantage of an existing 32-bit register interface to allow the DSP list coprocessor to simultaneously load two 16-bit sized DSP variables (either two real numbers or one complex number) into the list memory of the DSP list coprocessor.

Twelfth, the architecture of the data processor supports context switching easily through the list memory construct. Thus the architecture is extensible to support multiple contexts in hardware to avoid the normal overhead associated with context switching.

Thirteenth, the data processor further optimizes the overall performance of the RISC processor core in terms of processing time and power consumption by providing a rich set of instructions executable by the DSP list coprocessor to perform useful functions. Examples of such functions include wrapping an address within a specified range and computing an autocorrelation array from an input array loaded into the lists internally within the DSP list coprocessor. Many other useful functions will also be apparent to those of ordinary skill in the art from the description of the instruction set above.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A data processor comprising:
a processor core;
an interface coupled to said processor core; and
a coprocessor coupled to said processor core via said interface, said coprocessor including a first list memory,
wherein in response to a predetermined instruction said processor core provides an operand to said coprocessor via said interface,
wherein said coprocessor stores said operand in said first list memory and performs an operation corresponding to said predetermined instruction using a plurality of values from said first list memory to provide a result.

2. The data processor of claim 1 wherein said operation corresponding to said predetermined instruction comprises a cyclic redundancy check (CRC) calculation.

3. The data processor of claim 1 wherein said operation corresponding to said predetermined instruction comprises a polynomial evaluation.

4. The data processor of claim 1 wherein said coprocessor further includes a second list memory, and further performs said operation corresponding to said predetermined instruction using a plurality of values from said second list memory to provide said result.

5. The data processor of claim 4 wherein said plurality of values from said first list memory comprise sampled data values, said plurality of values from said second list memory comprises a plurality of filter coefficients, and said operation corresponding to said predetermined instruction comprises a finite impulse response (FIR) filter output calculation.

6. The data processor of claim 1 wherein said processor core further signals said predetermined instruction to said coprocessor via said interface.

7. The data processor of claim 1 wherein said processor core comprises a reduced instruction set computer (RISC) processor.

8. The data processor of claim 1 wherein said coprocessor comprises a first multiply and accumulate (MAC) unit.

9. The data processor of claim 8 wherein said coprocessor further comprises a second MAC unit and wherein each of said first and second MAC units has a selectable saturation mode.

10. The data processor of claim 9 wherein said selectable saturation mode of each of said first and second MAC units comprises one of a 32-bit saturation mode, and a 40-bit saturation mode.

11. The data processor of claim 9 wherein said coprocessor is responsive to a predetermined instruction to cause said first and second MAC units to perform respective MAC operations and to combine unsaturated outputs of said first and second MAC units to form a second result.

12. The data processor of claim 1 wherein said processor core, said coprocessor, and said interface are combined on a single integrated circuit.

13. For use in a data processor including a central processing unit that executes instructions, a coprocessor comprising:
control logic adapted to be coupled to the central processing unit via an interface for receiving instructions and operands over said interface;
a first list memory for storing a plurality of values including said operands; and
arithmetic circuitry coupled to said first list memory;
wherein responsive to a predetermined instruction said control logic causes said arithmetic circuitry to perform an operation corresponding to said predetermined instruction using a plurality of values from said first list memory to provide a result.

14. The coprocessor of claim 13 wherein said operation corresponding to said predetermined instruction comprises a cyclic redundancy check (CRC) calculation.

15. The coprocessor of claim 13 wherein said operation corresponding to said predetermined instruction comprises a polynomial evaluation.

16. The coprocessor of claim 13 wherein said arithmetic circuitry comprises a first multiply and accumulate (MAC) unit.

17. The coprocessor of claim 16 wherein said arithmetic circuitry further comprises fix-up logic coupled to said first MAC unit for adjusting a format of an output of said first MAC unit to provide said result.

18. The coprocessor of claim 17 wherein said fix-up logic selectively performs saturation, scaling, and rounding.

19. The coprocessor of claim 16 wherein the coprocessor further comprises a second MAC unit and wherein each of said first and second MAC units has a selectable saturation mode.

20. The coprocessor of claim 19 wherein said selectable saturation mode of each of said first and second MAC units comprises one of a European Telecommunication Standards Institute (ETSI) saturation mode, and an Advanced Micro Devices (AMD) saturation mode.

21. The coprocessor of claim 19 wherein the coprocessor is responsive to a predetermined instruction to cause said first and second MAC units to perform respective MAC operations and to combine unsaturated outputs of said first and second MAC units to form a second result.

22. The coprocessor of claim 13 further comprising a second list memory coupled to said control logic wherein said control logic is further responsive to said predetermined instruction to cause said arithmetic circuitry to perform said operation on a plurality of values from said second list memory to provide said result.

23. The coprocessor of claim 22 wherein said operation corresponding to said predetermined instruction comprises a finite impulse response (FIR) filter output calculation.

24. A data processor comprising:
a processor core;
an interface coupled to said processor core; and
a coprocessor coupled to said interface,
wherein in response to a first predetermined instruction said processor core provides an instruction and an operand value to said coprocessor via said interface, and said coprocessor initiates a first predetermined operation according to said first predetermined instruction;
in response to a second predetermined instruction said coprocessor provides said result to said interface upon completion of said first predetermined operation.

25. The data processor of claim 24 wherein said first predetermined instruction comprises a finite impulse response (FIR) filter start instruction, and said second predetermined instruction comprises an FIR filter stop instruction.

26. The data processor of claim 25 wherein in response to said FIR filter start instruction, said processor core continues executing instructions, and in response to said FIR filter stop instruction, said processor core halts further instruction processing until said coprocessor signals that said predetermined operation is complete.

27. The data processor of claim 24 wherein said coprocessor includes a list memory for storing said operand.

28. The data processor of claim 27 wherein said coprocessor performs said operation corresponding to said predetermined instruction using a plurality of values from said list memory.

29. The data processor of claim 24 wherein said processor core, said interface, and said coprocessor are combined on a single integrated circuit.

30. A data processing system comprising:
a central processing unit;
a memory coupled to said central processing unit for storing a plurality of operands;
an interface coupled to said central processing unit; and
a coprocessor coupled to said interface including a first list memory;
wherein in response to a predetermined instruction said central processing unit provides an operand to said coprocessor via said interface,
wherein said coprocessor stores said operand in said first list memory and performs an operation corresponding to said predetermined instruction using a plurality of values from said first list memory to provide a result.

31. The data processing system of claim 30 wherein said operation corresponding to said predetermined instruction comprises a cyclic redundancy check (CRC) calculation.

32. The data processing system of claim 30 wherein said operation corresponding to said predetermined instruction comprises a polynomial evaluation.

33. The data processing system of claim 30 wherein said coprocessor further includes a second list memory, and further performs said operation corresponding to said predetermined instruction using a plurality of values from said second list memory to provide said result.

34. The data processing system of claim 33 wherein said plurality of values from said first list memory comprise sampled data values, said plurality of values from said second list memory comprises a plurality of filter coefficients, and said operation corresponding to said predetermined instruction comprises a finite impulse response (FIR) filter output calculation.

35. The data processing system of claim 30 wherein said central processing unit further signals said predetermined instruction to said coprocessor via said interface.

36. The data processing system of claim 30 wherein said central processing unit comprises a reduced instruction set computer (RISC) processor core.

37. The data processing system of claim 30 wherein said coprocessor comprises a first multiply and accumulate (MAC) unit.

38. The data processing system of claim 37 wherein said coprocessor further comprises a second MAC unit and wherein each of said first and second MAC units has a selectable saturation mode.

39. The data processing system of claim 38 wherein said selectable saturation mode of each of said first and second MAC units comprises one of a 32-bit saturation mode, and a 40-bit saturation mode.

40. The data processing system of claim 38 wherein said coprocessor is responsive to a predetermined instruction to cause said first and second MAC units to perform respective MAC operations and to combine unsaturated outputs of said first and second MAC units to form a second result.

41. The data processing system of claim 30 wherein said central processing unit, said coprocessor, and said interface are combined on a single integrated circuit.

42. The data processing system of claim 30 wherein said memory comprises a random access memory (RAM) and a flash electrically erasable programmable read only memory (EEPROM). We currently use mask programmed ROM and a patch RAM program store.

43. A method for efficiently operating a data processing system comprising the steps of:
loading an operand into a register of a central processing unit in response to a first instruction;
providing said operand from said register to an interface in response to a second instruction;
storing said operand in a first list memory of a coprocessor coupled to said interface in response to said second instruction; and
performing, in said coprocessor, a predetermined operation corresponding to said second instruction using a plurality of values from said first list memory to provide a result.

44. The method of claim 43 wherein said step of loading comprises the step of loading said operand into a general purpose register of said central processing unit.

45. The method of claim 43 wherein said step of performing said predetermined operation comprises the step of performing a cyclic redundancy check (CRC) operation.

46. The method of claim 43 wherein said step of performing said predetermined operation comprises the step of performing a polynomial evaluation.

47. The method of claim 43 wherein said step of performing said predetermined operation comprises the step of performing said predetermined operation using said plurality of values from said first list memory and a plurality of values from a second list memory of said coprocessor.

48. The method of claim 47 wherein said step of performing said predetermined operation further comprises the step of calculating an output of a finite impulse response (FIR) filter.

49. The method of claim 48 wherein said step of calculating said output of said finite impulse response (FIR) filter comprises the step of calculating said output of said finite impulse response (FIR) filter using a multiply-accumulate unit of said coprocessor.

50. The method of claim 44 further comprising the step of removing said operand from said first list memory in response to a predetermined event.
